(19) United States
(12) Patent Application Publication
(10) Pub. No.: US 2007/0210909 A1
(43) Pub. Date: Sep. 13, 2007

(54) Intrusion detection in an IP connected security system

(75) Inventor: Kenneth L. Addy, Massapequa, NY (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/409,877

(22) Filed: Apr. 24, 2006

Related U.S. Application Data
(60) Provisional application No. 60/781,349, filed on Mar. 9, 2006.

(51) Int. Cl. G08B 29/00

(52) U.S. Cl. 340/506

(57) ABSTRACT

An intrusion detection device and method in an IP connected security system is disclosed. An intrusion detection device is coupled to primary and secondary communication devices of a security system so that when a Internet attack is detected, communication between the security system and a central monitoring station occurs over the secondary communication device rather than the primary communication device. The invention preserves communication between the security system and the central monitoring station even when a denial of service type attack is occurring so that physical premise security is uncompromised.

### CROSS REFERENCE TO RELATED APPLICATION

The present application claims priority from U.S. Provisional Application No. 60/781,349 filed on Mar. 9, 2006.

### BACKGROUND OF THE INVENTION

1. Field of the Invention

The invention relates to residential and commercial security systems, and more particularly to an intrusion detection in an IP connected security system.

2. Discussion of the Prior Art

Many modern residential and commercial security systems are connected to a central monitoring station via the internet or an intranet. The advantages of such a setup are many. The use of internet protocol (IP) packetized data for transmitting status and updates to and from the security system allows for routine updates to the system. Also, fully digital sensors can be added incrementally to the system without compromising the existing infrastructure. Operators can also match many wired and wireless components onto the system without compromising the integrity of the system.

However, with the advantages of a IP-connected security system are a host of disadvantages. Some of those disadvantages stem from having a security system occupy a node on the Internet. In order to receive and transmit IP packets, the security system will have an IP address and a gateway router associated with the address. It is fairly easy to find an IP address and attack the IP address using a variety of attacks to shut down the IP address. These attacks can be engineered by criminals hoping to compromise the security system, disgruntled employees, hackers and competitors. As security systems expand to take on more duties (including surveillance, facility access control, etc.), the disabling of a security system by an Internet attack can have dire consequences. Furthermore, since IP attacks at security system IP addresses can frequently go unnoticed at the facility, the attacks can pose even bigger threats to security systems which protect the physical premises.

### SUMMARY OF THE INVENTION

The present invention provides a device and method for detecting and responding to an IP intrusion in a security system. An intrusion detection device is coupled to primary and secondary communication devices of a security system so that when a Internet attack is detected, communication between the security system and a central monitoring station occurs over the secondary communication device rather than the primary communication device. The invention preserves communication between the security system and the central monitoring station even when a denial of service type attack is occurring so that physical premise security is uncompromised.

In one aspect the invention is a security system comprising: a control panel; sensors electrically coupled to said control panel; a primary communication device for transmitting and receiving data; a secondary communication device for transmitting and receiving data; and an intrusion detection device coupled to said control panel, wherein said intrusion detection device, upon detection of an intrusion, switches communication to said secondary communication device.

In another aspect, the invention is a method of detecting intrusions to a security system, said security system including a control panel; sensors electrically coupled to said control panel; a primary communication device coupled to said control panel for transmitting and receiving data; a secondary communication device for transmitting and receiving data; and an intrusion detection device coupled to said control panel, said method comprising the steps of: at the intrusion detection device, detecting an intrusion attempt; raising a local alert on said control panel; and switching communication to said second communication device.

### BRIEF DESCRIPTION OF THE DRAWINGS

The foregoing objects and advantages of the present invention for intrusion detection in a IP connected security system may be more readily understood by one skilled in the art with reference being had to the following detailed description of several embodiments thereof, taken in conjunction with the accompanying drawings in which:

FIG. 1 is a schematic diagram of a prior art security system;

FIG. 2 is a schematic diagram of a security system in accordance with one embodiment of the invention; and

FIG. 3 is a flowchart diagram of the steps taken at the security system to detect intrusions.

### DETAILED DESCRIPTION OF THE INVENTION

Reference will now be made in detail to embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, the present invention may be practiced without those specific details. In other instances, well known methods, procedures, components and circuits have not been described in detail as not to unnecessarily obscure aspects of the present invention.

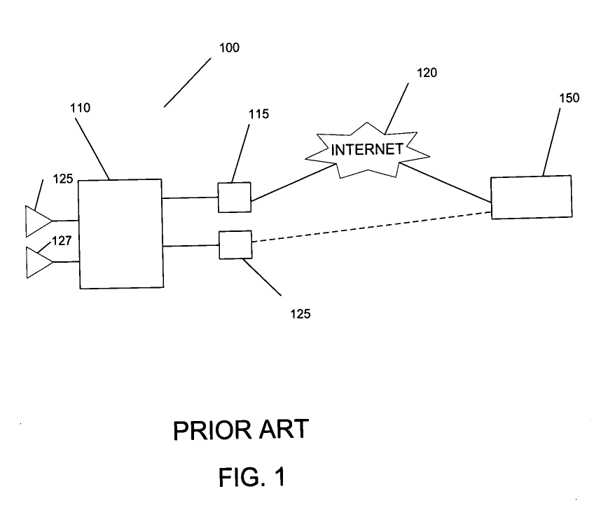

Referring to FIG. 1, there is shown a schematic diagram of a typical residential or commercial security system 100. Security system 100 may include a control panel 110 which may use proprietary buses and separate wiring and cables within a building to communicate with a variety of sensors 125 and 127. The sensors 125, 127 may be, for example, radio frequency motion sensors, cameras, alarm reporting devices, or the like, which generally report intrusions or sense emergencies in the building to the control panel. The control panel 110 typically houses a display means for displaying the status of the various sensors and for alerting local facility managers and residents if a physical security breach or emergency has occurred. The control panel also may contain means for resetting sensors and running diagnostics on the sensors.

The control panel is coupled to IP communication device 115 which connects the security system to a central monitoring station 150. It will be understood that the IP communication device may be hubs, switches or routers which enable communication through messages compliant with Internet Protocol. The IP communication device 115 communicates to the central monitoring station 150 through the Internet 120. The central monitoring station 150 may maintain contact with the control panel 110 so that the status of the system is kept up to date at the central monitoring station.

The security system 100 has a secondary communication device 125 for providing communication to the central monitoring station 150 when the primary method of communication is unavailable. Such secondary communication device 125 may be, for example, a GSM dialer configured to communicate wirelessly to the central monitoring station. Such back-up communication equipment 125 may be a telephone modem configured for communicating with the central monitoring station 150 through plain old telephone service (POTS) lines. Although the back-up communication equipment 125 is illustrated as a separate component, it may be integrated within the control panel 110.

Generally, concurrent with the rise in connectivity among diverse computer networks and the corresponding increase in dependence on networked information systems, there has been a dramatic increase in the need for robust security to enforce restrictions on access to and prevent intrusion on security systems. The topology of the interconnected networks has also grown increasingly complex, and often involves open networks such as the internet or the extranet that expose security systems to increased threats of attack. No single solution has yet been proposed that addresses the current needs for intrusion detection and response for a security system. Additionally, the intrusion detection and response of a security system must be cognizant of the special needs of a security system.

For instance, a security system at a residential or commercial facility may not be monitored by facility personnel on a regular basis. Since most of the control panel data is transmitted and received at a central monitoring station, facility personnel may not actively manage the control panel, instead, only paying heed when a local alarm or alert is raised by the security system. Further, unlike when a website is attacked by a coordinated Internet attacks and the operator of the website chooses just to disable the website until the attack is ended, an Internet attack at a security system may be part of a coordinated attack in conjunction with a physical attack on the facility. Therefore, it is especially important that communication with the central monitoring station is maintained during an Internet attack.

The present invention contemplates an intrusion detection device which monitors Internet traffic and, if certain conditions are met, disables the primary connection to the central monitoring station so that secondary communication is established.

Methods used by intruders to gain unauthorized access to computer networks evolve in sophistication in lock step with advances in security technology. It is typical, however, that successful attacks on network systems often begin by attacking the security subsystems in place on the target network that are responsible for detecting common intrusion signatures, disabling those systems and destroying evidence of the intrusion. Such attacks include a “denial-of-service” attack, which is an attack on a computer system or network that causes a loss of service to users, typically the loss of network connectivity and services by consuming the bandwidth of the victim network or overloading the computational resources of the victim system. A “smurf” attack is a “denial-of-service” attack, which uses spoofed broadcast IP messages to flood a target system. A “banana” attack involves redirecting outgoing messages from the network back onto the network, preventing outside access, as well as flooding the client with the sent packets.

Attempts to gain unauthorized access to computer networks capitalize on inherent loopholes in a network's security topology. It is known, for example, that weaknesses in individual security components are often sought out and successfully exploited. The rapid introduction of new technology exacerbates the problem, creating or exposing additional weaknesses that may not become known even after a breach in security has already occurred. Some currently available intrusion tools allow an intruder to evade detection by intrusion detection systems.

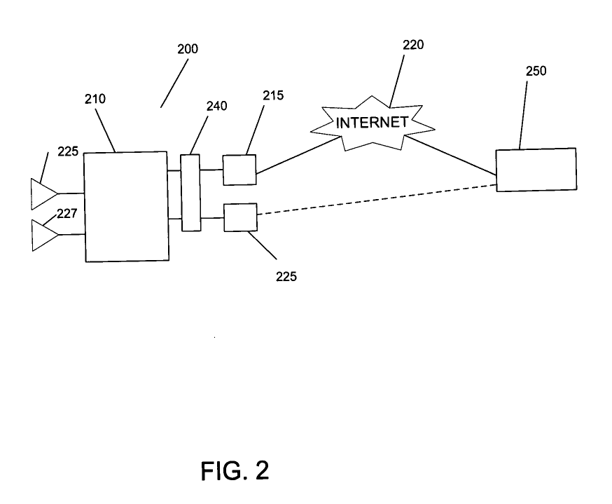

Referring now to FIG. 2, there is shown a schematic diagram of a security system 200 in accordance with one embodiment of the invention. Security system 200 includes a control panel 210, which uses proprietary buses and separate wiring and cables within a building to communicate with a variety of sensors 225 and 227. The sensors 225, 227 may be, for example, radio frequency motion sensors, cameras, alarm reporting devices, or the like, which generally report intrusions or sense emergencies in the building to the control panel. The control panel 210 houses a display means (not shown) for displaying the status of the various sensors and for alerting local facility managers and residents if a physical security breach or emergency has occurred. The control panel also may contain means for resetting sensors and running diagnostics on the sensors.

The control panel is coupled to an intrusion detection device 240, which is further coupled to IP communication device 215. The IP communication device may be hubs, switches or routers, which enable communication through messages compliant with Internet Protocol. In one embodiment, the IP communication device 215 is a gateway router for directing data traffic onto and from the Internet. The IP communication device 215 communicates to the central monitoring station 150 through the Internet 220. The central monitoring station 250 may maintain contact with the control panel 210 so that the status of the system is kept up to date at the central monitoring station.

The security system 200 includes a secondary communication device 225 for providing communication to the central monitoring station 250 when the primary method of communication is unavailable. The secondary communication device is also coupled to the intrusion detection device 240. Such secondary communication device 225 may be, for example, a GSM dialer configured to communicate wirelessly to the central monitoring station. Such back-up communication equipment 225 may be a telephone modem configured for communicating with the central monitoring station 250 through POTS lines. Although the back-up communication equipment 225 is illustrated as a separate component, it may be integrated within the control panel 210.

The intrusion detection device 240 may include a firewall for controlling access to the security system. The firewall is configurable and serves to control access by hosts on the Internet to resources on the network. This protects the security system from intruders outside the firewall by essentially filtering out packets of information transmitted over the Internet. The intrusion detection device 240 further includes a packet sensor, which reads packets passing through the firewall, and looks for inherent signatures of an Internet attack.

Preferably, the intrusion detection device is embedded in the control panel as a software package and implemented on computers comprising at least a master system and the security subsystem. In another embodiment, the intrusion detection device is implemented in firmware and loaded into a processing unit associated with the control panel. This allows for updates by the central monitoring station as signatures for new types of attacks are discovered.

During operation, the intrusion detection device 240 monitors the message activity at the security system. All outgoing and incoming message packets are examined at the intrusion detection device. The intrusion detection device examines individual packets and gathers data related to the originating IP address of each message. If, for instance, bursts of data messages from one specific IP address are directed to the security system, a denial-of-service type attack may be occurring. In another instance, if the burst of data traffic is outside the statistical range of normal data traffic for the security system, a denial-of-service attack from spoofed IP addresses may be occurring.

A host of factors related to the security system, including vulnerability, visibility of the target, data traffic capacity, time of day, and other factors may figure into how the intrusion detection device handles anomalous data message activity at the security system. These factors can be coded into the software or firmware implementation of the intrusion detection device so that trigger levels for raising an alarm or alert can be modified.

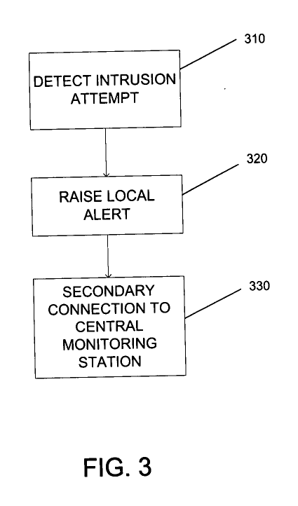

Referring now to FIG. 3, there is shown the steps involved in a method of intrusion detection for a security system. In step 310, an intrusion attempt is detected at the intrusion detection device. For instance, if the intrusion detection device detects a certain data traffic over a predefined trigger number, the intrusion detection device logs the event as an intrusion attempt. In step 320, the intrusion detection device raises a local alert at the control panel. The control panel has a display means, which alerts local facility personnel of an intrusion attempt. This may be accomplished by means of a warning displayed on the display means of the control panel. In step 330, the intrusion detection device enables the secondary communication device for communications to and from the central monitoring station. The intrusion detection device may also disable the primary communication device so that data message traffic over the primary communication device is ignored.

The preferred embodiment of the present invention, a monitored voltage inverter for a security system, is thus described. While the present invention has been described in particular embodiments, it should be appreciated that the present invention should not be construed as limited by such embodiments, but rather construed according to the below claims.

What is claimed is:

1. A security system comprising:
a control panel;
sensors electrically coupled to said control panel;
a primary communication device for transmitting and receiving data;
a secondary communication device for transmitting and receiving data; and
an intrusion detection device coupled to said control panel,
wherein said intrusion detection device, upon detection of an intrusion, switches communication to said secondary communication device.

2. The security system of claim 1 wherein said intrusion detection device includes a firewall.

3. The security system of claim 1 wherein said primary communication device is a gateway router.

4. The security system of claim 1 wherein said primary communication device is a hub.

5. The security system of claim 1 wherein said primary communication device is a switch.

6. The security system of claim 1 wherein said control panel includes a display means.

7. The security system of claim 6 wherein said display means includes means for displaying a local alert.

8. The security system of claim 1 wherein said secondary communication device is a wireless dialer.

9. The security system of claim 1 wherein said secondary communication device is a telephone modem.

10. The security system of claim 1 wherein said intrusion detection device is configured for detecting packet intrusions to said security system.

11. A method of detecting intrusions to a securing a security system, said security system including a control panel; sensors electrically coupled to said control panel; a primary communication device coupled to said control panel for transmitting and receiving data; a secondary communication device for transmitting and receiving data; and an intrusion detection device coupled to said control panel, said method comprising the steps of:
at the intrusion detection device, detecting an intrusion attempt;
raising a local alert on said control panel; and
switching communication to said second communication device.

12. The method of claim 11 further comprising the step of disabling communication to said primary communication device.

13. The method of claim 11 wherein said intrusion detection device includes a firewall.

14. The method of claim 11 wherein said primary communication device is a gateway router.

15. The method of claim 11 wherein said primary communication device is a hub.

16. The method of claim 11 wherein said primary communication device is a switch.

17. The method of claim 11 wherein said control panel includes a display means.

18. The method of claim 17 wherein said local alert is displayed at said display means.

19. The method of claim 11 wherein said secondary communication device is a wireless dialer.

20. The method of claim 11 wherein said secondary communication device is a telephone modem.

21. The method of claim 11 wherein said intrusion detection device is configured for detecting packet intrusions to said security system.
